(19) United States
(12) Patent Application Publication
(10) Pub. No.: US 2005/0144647 A1
(43) Pub. Date: Jun. 30, 2005

(54) Wireless provider monitoring of catv segment

(76) Inventors: Mordechai Zussman, Kiriat Bialik (IL); Michael Anghel, Ramat-Aviv (IL); Harel Zussman, Netanya (IL); Dan Shklarsky, Hifa (IL)

Correspondence Address: SUGHRUE MION, PLLC, 2100 PENNSYLVANIA AVENUE, N.W., SUITE 800, WASHINGTON, DC, 20037, US

(21) Appl. No.: 10/505,210

(22) PCT Filed: Nov. 21, 2002
(86) PCT No.: PCT/US02/33650

Related U.S. Application Data
(60) Provisional application No. 60/357,650, filed on Feb. 20, 2002.

(51) Int. Cl. H04N 7/173

(52) U.S. Cl. 725/106

(57) ABSTRACT

A monitor enabled amplifier in the CATV segment of a wireless network includes a cellular interface communicating with a network control center to provide status information pertaining to the CATV network. A monitor enabled cable Mount cellular antenna with a twin mode cellular interface provide status and location correlation information to the network control center. The location correlation information supports an emergency response system and differential billing.

### CROSS-REFERENCE TO RELATED APPLICATIONS

This application claims the benefit of U.S. Provisional Application No. 60/357,650, filed on Feb. 20, 2002, the disclosure of which is incorporated herein by reference, in its entirety, for all purposes.

### BACKGROUND

1. Field of the Invention

This description relates to the monitoring of a system for providing cellular service over a CATV or similar network In particular, this description relates to providing a method and equipment for enabling a wireless provider to monitor cellular activity over a CATV segment. As used herein, the term “cellular” generally refers to any wireless communications, and includes, but is not limited to, the following systems: UMTS, GSM, PCS, CDMA, TDMA, and PDC type networks.

2. Description of Related Art

The advantages of using a CATV system for carrying cellular traffic can be readily grasped by looking at the disadvantages of traditional cellular systems.

The basic theory by which mobile radio and cellular networks operate is well known. Geographically distributed network access points, each defining cells of the network, characterize cellular radio networks. The geographically distributed network access points are typically referred to as base stations BS or base transceiver stations BTS, and includes transmission and reception equipment for transmitting signals to and receiving signals from mobile radio terminals (MT).

Each cell (or sector) is using only part of the total spectrum resources licensed to the network operator, but the same capacity resources (either frequency or code), may be used many times in different cells, as long as the cell to cell interference is kept to a well defined level. This practice is known as the network reuse factor. The cells may be subdivided further, thus defining microcells. Each such microcell provides cellular coverage to a defined (and usually small) area. Microcells are usually limited in terms of their total available capacity.

The overall demand for both indoor and outdoor mobile services had caused cellular network operators to develop an intensive network of BTSs in urban areas. This has improved spectrum utilization (increased network capacity) at ground level, but has aggravated the problem in high-rise buildings where MTs may now ‘see’ several BTSs on the same frequency or code.

Cells in a cellular radio network are typically connected to a higher-level entity known as Mobile Switching Center (MSC), which provides certain control and switching functions for all the BTSs connected to it. All MSCs are connected to each other, and also to the public switched telephone network (PSTN), or may themselves have such a PSTN interface.

A computer record of each cellular call is made at what may be referred to as a network control center. Such a record includes information such as the calling party, the called party, roaming information, call duration, and the like

The conventional implementation of mobile radio networks has had some important limitations. When operating above 1 GHz, it is necessary in a conventional mobile radio network to build numerous base stations to provide the necessary geographic coverage and to supply enough capacity for high-speed data applications. The base stations require an important amount of real estate, and are very unsightly.

Another limitation is that, since cellular towers are expensive, and require real estate and costly equipment, it is economically feasible to include in a network only a limited number of them. Accordingly, the size of cells might be quite large, and it is therefore necessary to command the mobile radio terminals to radiate at high-power so as to transmit radio signals, strong enough for the geographically dispersed cellular towers to receive.

As the cell radius becomes larger, the average effective data rate per user in most packet based protocols decreases accordingly and the high-speed data service might deteriorate.

Yet another limitation to cellular radio networks as conventionally implemented is that the cellular antennas are typically located outside of buildings, even though it would be highly beneficial to provide cellular service inside buildings. The penetration of cellular signals for in-building applications requires high power sites, or additional sites or repeaters to overcome the attenuation inherent with in-building penetration. As frequency increases, the in-building signal level decreases accordingly.

Because the base station antennas are usually located outside of buildings, it is difficult for mobile radio terminals to transmit signals strong enough to propagate effectively from inside of the building to outside of the building. Therefore, the use of mobile terminals inside buildings results in reduced data rate and consumes substantial amount of the limited battery time.

Yet another limitation of UMTS, GSM900, GSM1800, PCS1900, TDMA800, CDMA800 or PDC radio networks as conventionally implemented is the inherent limited capacity of each and every BTS to provide voice and data service. This capacity shortage is due to the way the spectrum resources are allocated to each BTS.

To provide for reasonable voice & data quality, each BTS can use only a part of the total spectrum resources owned by the cellular operator. Other BTSs could reuse the same part of the spectrum resources as a given BTS, but a pattern of geographic dispersion would have to be respected. This is called a code reuse factor for CDMA based technologies, and a frequency reuse factor for TDMA based technologies.

Because CATV is so ubiquitous today, even in rural areas, it becomes very interesting to attempts to overcome the above identified limitations of cellular systems by taking advantage of the bandwidth of the CATV networks.

FIG. 1 shows a CATV system, in highly simplified schematic form. In the CATV system, the CATV head end is connected to a CATV cable network. The CATV cable network includes various equipment, such as amplifiers. Most CATV networks today are bidirectional. That is to say, communications from the CATV head end toward the end user (i.e., downstream communications) and also communications from the end user to the CATV head end (i.e., upstream communications) are possible.

The CATV network shown in FIG. 1 is a bidirectional system. The CATV amplifiers are bidirectional as well. Upstream communications are carried in a relatively narrow band of 5-45 MHz. Downstream communications are carried in a relatively wide band of 50-750 MHz or 50-860 MHz, depending on the particular system.

The communications traveling downstream from the CATV head end are passed on through a tree-shaped network to a set-top box (STB). The STB connects to the television set. Of course, it is quite possible that the television set includes the appropriate equipment to allow the connection of the cable without the use of a STB.

FIG. 2 shows a conventional approach to carrying cellular communications over such a network In this approach, the public land mobile network (PLMN) is connected to the cable system via an interface I/F. Downlink communications from the PLMN are carried through the CATV amplifiers, and the CATV network through a remote antenna driver (RAD). The RAD takes the downlink communications and broadcasts them to a mobile terminal such as a cellular telephone or the like.

Upstream communications from the mobile terminal travel through the RAD, and through the upstream portion of the bandwidth, through the CATV amplifiers, through the I/F, and then to the PLMN. Naturally, frequency conversion is necessary at the RAD and at the I/F so that the uplink and down communications can be put into the upstream and downstream bandwidth of the CATV network.

In a system such as that shown in FIG. 2, the wireless provider is to some degree dependent upon the CATV network. Unfortunately, the wireless provider has no way to know whether the CATV network is functioning properly, and cannot perform in a troubleshooting of the system without help from the CATV network provider.

Traditional cellular systems also suffer from the problem that it is difficult to locate a mobile terminal without complex triangulation calculations. Furthermore, traditional cellular systems lacks the wherewithal to provide for sophisticated differential billing arrangements. Both of these deficiencies arise from the fact that the size of cells is so large, even in the case of microcells.

### BRIEF SUMMARY OF THE INENTION.

One objective, among others, is to overcome or mitigate the above identified disadvantages of mobile radio networks by making it possible for a wireless provider to monitor the CATV segment of a system and which cellular traffic is carried over a CATV network.

Another objective is to provide for a smaller cell size so as to make it possible for improved mobile terminal location operations, even to the level of locating an apartment or other premises in which the customer is in when communicating a call.

Another objective is to provide improved and sophisticated differential billing arrangements such as an advantageous price for a customer calling from his own premises, a different price for a customer calling from another customer's premises, and still another price for a non-customer calling from a customer's premises.

The foregoing objects, and others that will become apparent after reading the description below, are achieved by providing a monitor enabled amplifier of a CATV system. The foregoing and other objects are also achieved by providing a monitor enabled cable mount cellular antenna.

These monitor enabled devices make it possible for the wireless provider to query them, and to obtain certain status information. These monitor enabled devices also make it possible for the wireless provider to have an improved and simple mobile terminal location ability which, in turn, gives rise to the possibility of sophisticated differential billing arrangements.

The invention is taught below by way of various specific exemplary embodiments explained in detail, and illustrated in the enclosed drawing figures. It will be appreciated, however, that the invention is much broader than the examples described below, and the examples are provided for the sake of teaching the invention in its presently preferred embodiment. The appended claims are intended to describe the actual scope of the invention.

### BRIEF DESCRIPTION OF THE DRAWINGS

The drawing figures depict, in highly simplified schematic form, embodiments reflecting the principles of the invention. Many items and details that will be readily understood by one familiar with this field have been omitted so as to avoid obscuring the invention. In the drawings:

FIG. 1 shows a conventional CATV network.

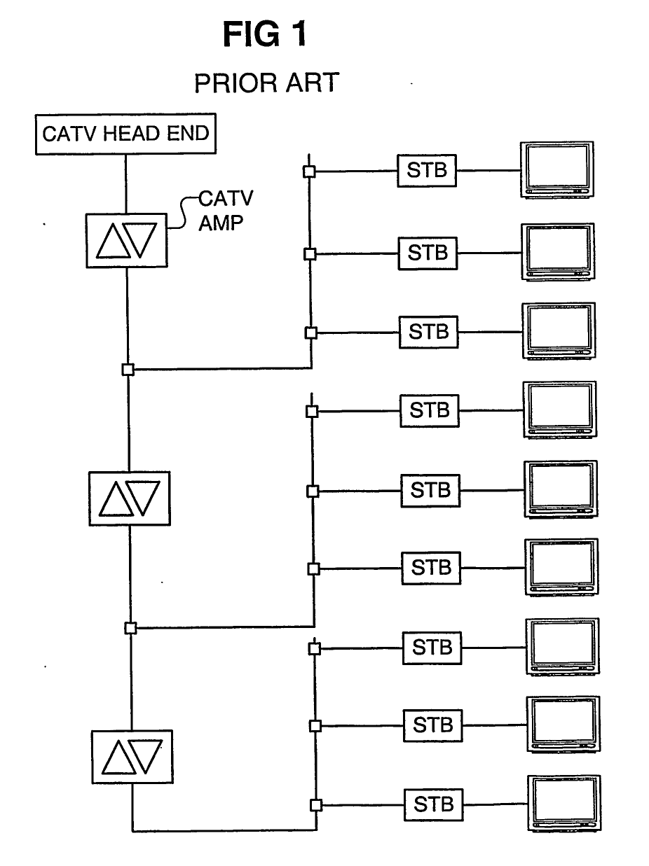

FIG. 2 shows a conventional approach to carrying cellular traffic over a CATV network.

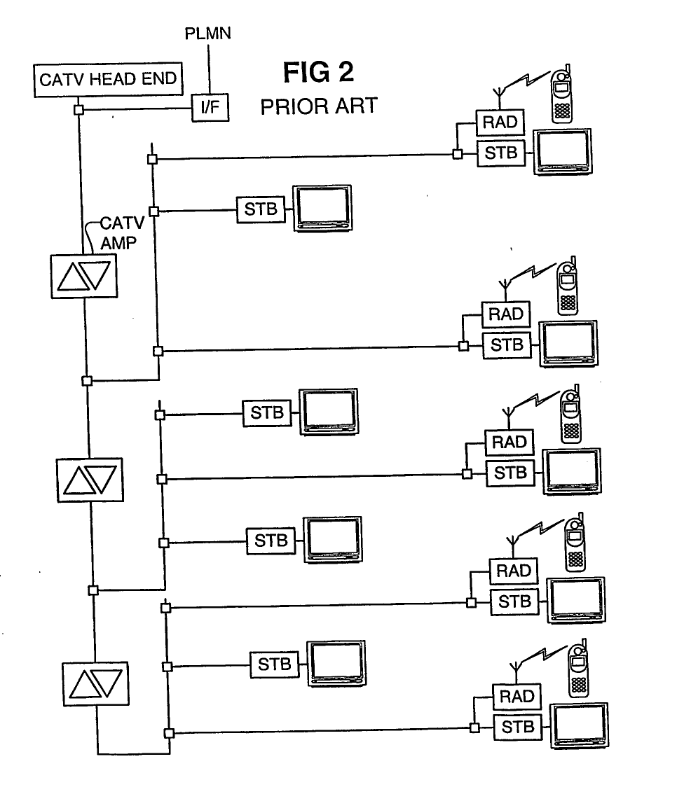

FIG. 3 shows an improved approach to carrying cellular traffic over a CATV network, by taking advantage of cellular bypass devices at each active component.

FIG. 4 shows a detailed view of a cellular bypass device.

FIG. 5 shows a highly simplified schematic view of a network coupling duplexer and a cable mount cellular antenna.

FIG. 6 shows a schematic view of an up and downconverter.

FIG. 7 shows a diagram illustrating how multiple providers and systems can be accommodated over one cable network.

FIG. 8 shows a schematic view of a frequency converter that may be used in a CATV network having more than one provider or system.

FIG. 9 shows a monitor enabled amplifier according to one aspect of the invention.

FIG. 10 shows the up and downconverter part of a monitor enabled amplifier.

FIG. 11 shows the cellular interface part of a monitor enabled amplifier.

FIG. 12 shows a flow diagram for a monitor enabled device according to one aspect of the invention.

FIG. 13 shows a flow diagram for a monitor enabled device according to another aspect of the invention.

FIG. 14 shows a monitor enabled amplifier according to yet another aspect of the invention.

FIG. 15 shows a flow diagram for a monitor enabled amplifier as depicted in FIG. 14.

FIG. 16 shows still another embodiment of a monitor enabled amplifier in which a twin mode cell interface is used.

FIG. 17 shows a flow diagram for the monitor enabled amplifier of FIG. 16.

FIG. 18 shows and other flow diagram according to a different aspect of the invention, for the monitor enabled amplifier of FIG. 16.

FIG. 19 shows a monitor enabled cable mount cellular antenna according to another aspect of the invention.

FIG. 20 shows a monitor enabled cable mount cellular antenna having a twin mode cellular interface according to still another aspect of the invention.

FIG. 21 shows a high-level view of a cable system and a PLMN system according to an embodiment of the invention.

FIG. 22 shows a high-level view of a cable system and a PLMN system according to a different embodiment of the invention featuring multiple cellular networks.

FIG. 23 shows a high-level view of a cable and PLMN system so as to explain improved mobile terminal locating capabilities.

FIG. 24 shows a simplified view of a mobile terminal communicating with and outdoor cellular antenna tower.

FIG. 25 shows a simplified view of the mobile terminal in FIG. 24 after being handed over to a monitor enabled cable mount cellular antenna according to one aspect of the invention.

FIG. 26 shows a flow diagram for the monitor enabled CMCA of FIG. 20 for supporting differential billing.

### DETAILED DESCRIPTION

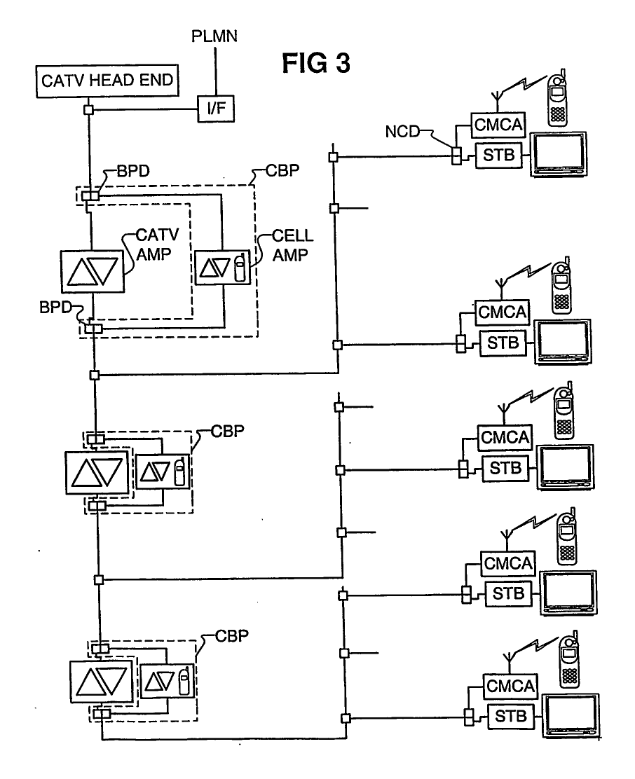

FIG. 3 shows a CATV segment in a hybrid wireless/CATV system in which the invention is implemented. In FIG. 3, the wireless uplink and downlink frequencies are not converted into the normal bandwidth of the CATV system. Instead, the uplink and downlink frequencies are converted into a part of the bandwidth above the CATV programming. That is to say, wireless communications are all carried above 860 MHz.

The CATV amplifier normally passes along only frequencies in the 5-45 MHz band for upstream communications, and filters out all other frequencies passing upstream. The CATV amplifier normally passes along only frequencies in the 50-750/860 MHz band for downstream communications, and filters out all other frequencies passing downstream. This poses a problem to carrying the cellular communications in a band above the normal CATV programming.

To overcome this problem, a cellular bypass (CBP) is installed at each active component (such as a CATV amplifier). The CBP includes a cellular amplifier and bypass devices (BPD). The CBP thus passes the uplink and downlink communications around the CATV amplifiers so that the cellular communications are not filtered out by the CATV amplifiers.

At each end user location, there is provided a network coupling device (NCD) and a cable mount cellular antenna (CMCA). The NCD passes CATV traffic to and from the STB and passes cellular traffic to and from the CMCA.

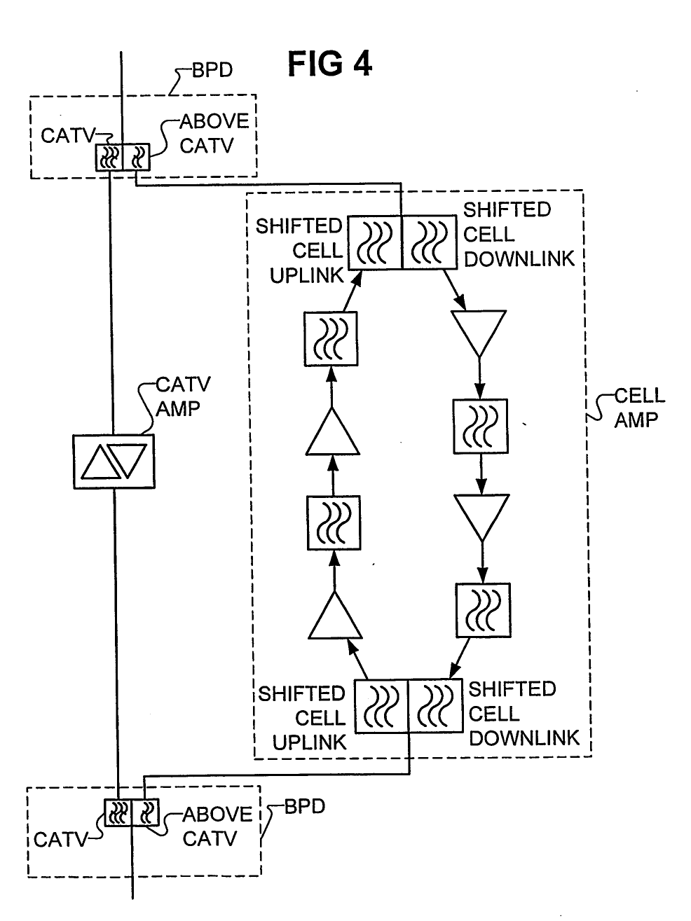

FIG. 4 shows a more detailed view of the cellular bypass (CBP). Each bypass device BPD includes filters that pass the CATV traffic (5-750/860 MHz) to the CATV amplifier, and that pass the cellular traffic to the cellular amp. The cellular uplink and downlink traffic is not at the normal cellular frequencies, but is shifted to another frequency band that is typically lower than the normal transmission frequencies, but higher than the CATV programming. As shown in FIG. 4, the shifted uplink and downlink traffic is amplified and then rejoined to the cable at the other bypass device BPD.

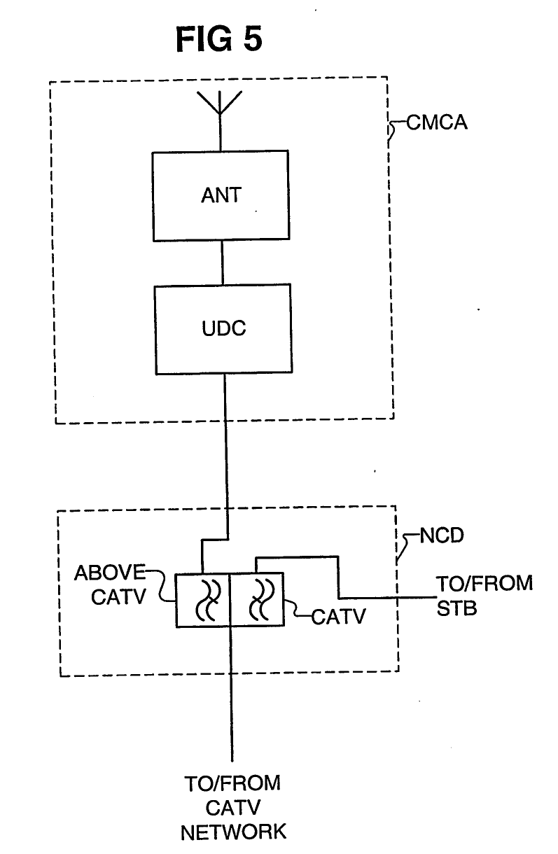

FIG. 5 shows the network coupling device NCD and the cable mount cellular antenna CMCA. The NCD simply passes the CATV traffic (860 MHz and below, for example) to the set-top box STB, and passes the cellular traffic (above 950 MHz, for example) to the CMCA.

The CMCA includes an up and downconverter UDC for converting the cellular frequencies from the shifted frequencies to the normal frequencies according to the particular standard being used for cellular communications. Likewise, the UDC also takes normal cell frequencies and converts them to shifted frequencies for transmission along the cable. The UDC may also be referred to, more simply, as a frequency converter.

The CMCA, in particular, takes downlink communications and up converts them from their shifted form, as received from the cable system, to their normal unshifted frequencies. Also, it takes uplink communications and down converts them from their normal unshifted frequencies, to a shifted frequencies for transmission along the cable system to the PLMN.

The up and downconverter UDC is coupled with and antenna for communicating with a mobile terminal at the normal cellular frequencies.

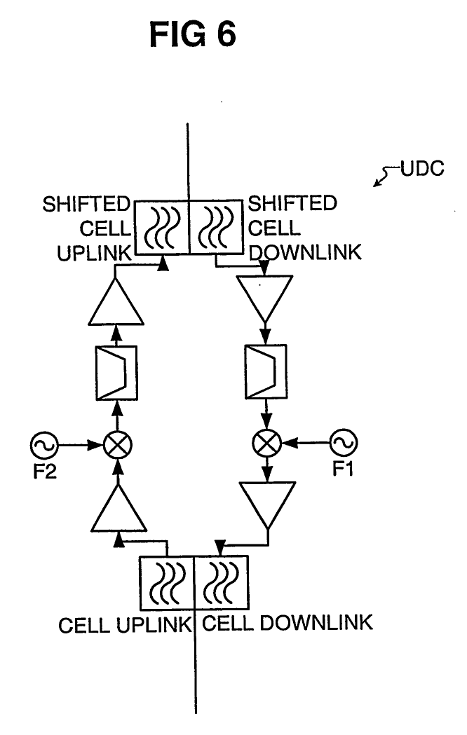

FIG. 6 shows the CMCA, in one exemplary embodiment. The signals from the NCD are communicated via filters at their shifted frequencies. The CMCA shown here exemplifies the approach of converting using only one oscillator. The single oscillator is appropriate when, as in this example, only one mobile radio system is being supported.

The downlink signals pass through filters and amplifiers in a manner well understood by those familiar with this field, and are mixed with a frequency F1 from a local oscillator source. The result, a downlink signal that has been shifted back to the original frequency, is amplified and passed through another filter.

The downlink cellular signal, restored to its original frequency, is communicated via indoor antenna ANT to the mobile terminal.

As to uplink signals, the cellular signals at their original frequency are received at indoor antenna ANT from the mobile terminal. The uplink signals pass through a filter, and are amplified and shifted with an amplifiers, a local oscillator at frequency F2, and a mixer. The shifted cellular signals pass through another filter and on to the NCD as shifted cell uplink signals.

The exemplary CMCA could be used with any mobile radio system. It will also be appreciated that, although the mobile terminal is typically thought of as being a cellular phone, any mobile station such as a PDA or the like would be appropriate to use with the system.

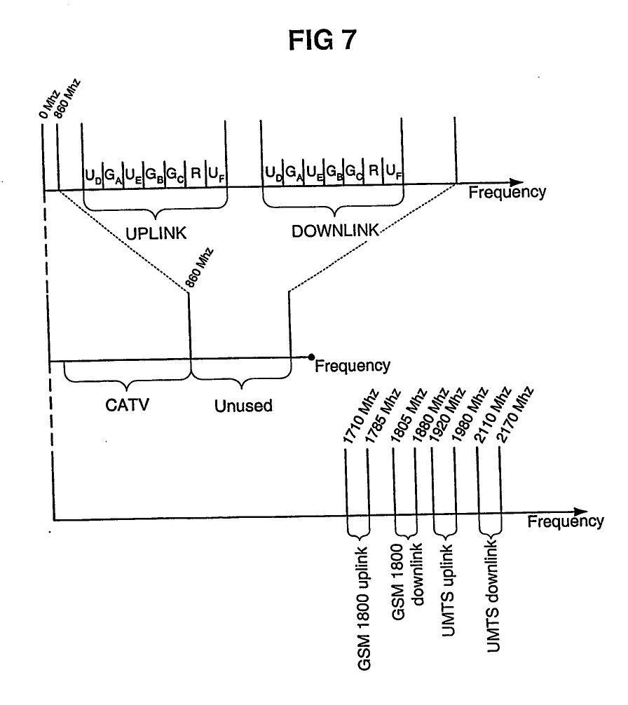

Multiple systems and multiple cellular providers can be supported on the same system by performing the frequency shifting into particular portions of the unused frequencies of the CATV system, as shown in FIG. 7.

FIG. 7 shows, as an example, the UMTS and GSM1800 frequencies before and after the frequency conversion. That is to say, the GSM 1800 system is frequency translated so that the uplink traffic occupies the part of the shifted uplink signals (UPLINK in the upper part of the figure) indicated by G_{A} (“G” for GSM 1800 and “A” for system A). This GSM 1800 system (A) is also frequency translated so that the downlink traffic occupies the part of the shifted downlink signals (DOWNLINK in the upper part of the figure) as indicated also by G_{A}.

Likewise, the exemplary figure shows how the signals of each of several other systems/providers B-F are frequency translated into the shifted uplink signals and the shifted downlink signals that are carried over the unused frequencies of the CATV system. In FIG. 7, provider B provides GSM service, and its uplink and downlink signals are frequency shifted to those indicated by “G_{B}”; provider C provides GSM service, and its uplink and downlink signals are frequency shifted to those indicated by “G_{C}”; providers D, E, and F each provide UMTS service, and their uplink and downlink signals are frequency shifted to those indicated by “U_{D}, “U_{E}”, and “U_{F}”, respectively. In the figure, the symbol “R” indicates a reserved band, which may be used for any particular purpose.

The sub-bands may thus each carry the traffic for a different service provider and a different system. In this example, 3 sub-bands of GSM1800 are frequency translated from their original band (1710-1785 Mhz & 1805-1880 Mhz) to anywhere within the unused portion of the CATV spectrum.

In addition, 3 sub-bands (each may be one 5 Mhz UMTS carrier) of UMTS are also similarly translated. Each up-link or downlink sub-band is translated independently by using a different local oscillator (as shown by the examples above). Guard bands between the sub-bands are not shown in the figure for the sake of simplicity. However, if guard bands are needed between the sub-bands, the local oscillator frequencies can be set so as to create them.

The sub-bands are created out of the original standard frequency allocation of mobile radio systems. The bandwidth of the sub-band to be translated is not limited by the example shown above. The mobile radio system provider may be offered to transport up to all the bandwidth he owns by this system.

It will be appreciated that the use of particular mobile radio systems in this example, and the shifting of their signals to particular parts of the unused CATV spectrum is for the sake of example only, and that virtually any combination of mobile radio systems from any set of mobile radio system providers can be handled in like manner. It will also be appreciated that the mobile radio signals can be shifted to any part of the unused spectrum of the CATV system.

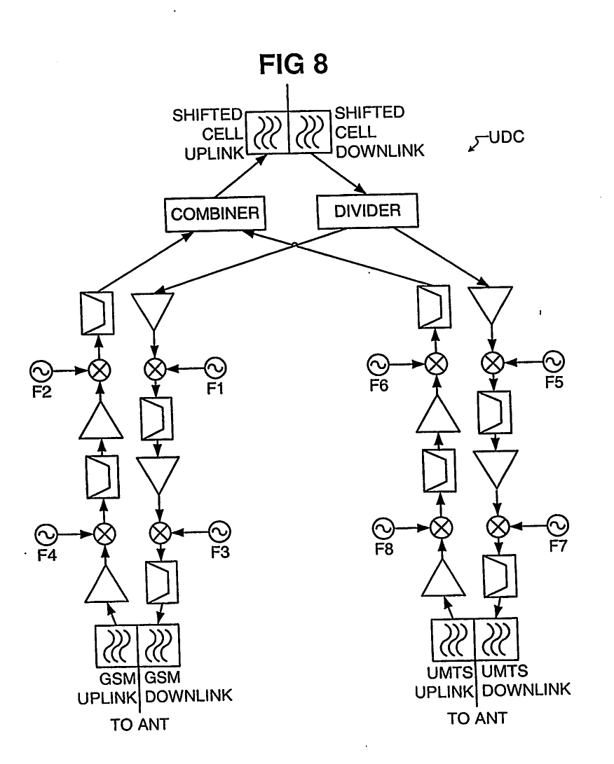

FIG. 8 shows an example of a UDC adapted for more than one system. In particular, the UDC is adapted for a situation in which a GSM provider and a UMTS provider are accommodated at the same time over the cable system. The shifted cellular signals are communicated as shown at the top of the figure via a combiner (for the uplink signals) and a divider (for the downlink signals).

The downlink signals are converted in a known manner to an intermediate frequency (with local oscillators F1/F5), and then converted to the normal cellular frequencies for GSM and UMTS, respectively (using F3/F7). These are passed onto the antenna unit ANT.

Likewise, the uplink signals are received from the antenna unit ANT and converted in the known manner (using F4/F8) to an intermediate frequency, and then converted (using F2/F6) to the shifted cellular frequencies and combined for carrying over the CATV network.

This figure shows a frequency converter UDC adapted for handling two systems, but the same approach could be taken for handling any arbitrary number of systems. Likewise, performing the intermediate frequency conversion could be performed even if only one system was being supported.

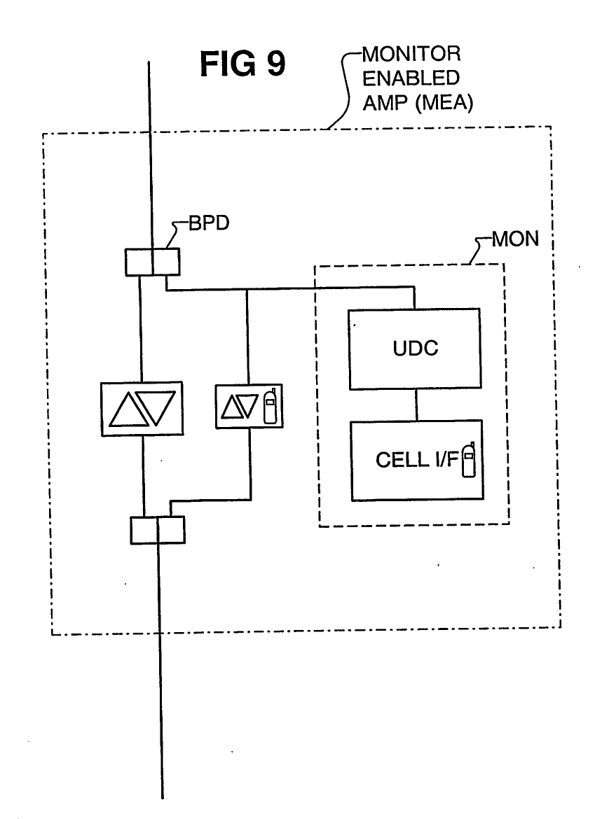

FIG. 9 shows a monitor enabled amplifier MEA according to one aspect of the invention. The monitor enabled amplifier MEA includes the items shown in FIG. 4, or devices that perform the similar function. In particular, the MEA includes a CATV amplifier, a cellular amplifier, and bypass devices BPD. What makes the MEA different from the apparatus shown in FIG. 4 is, in the main, the addition of a monitor MON as shown in FIG. 9.

The monitor MON includes an up and downconverter UDC and also a cellular interface CELL I/F. The monitor MON of the monitor enabled amplifier MEA will now be described in greater detail.

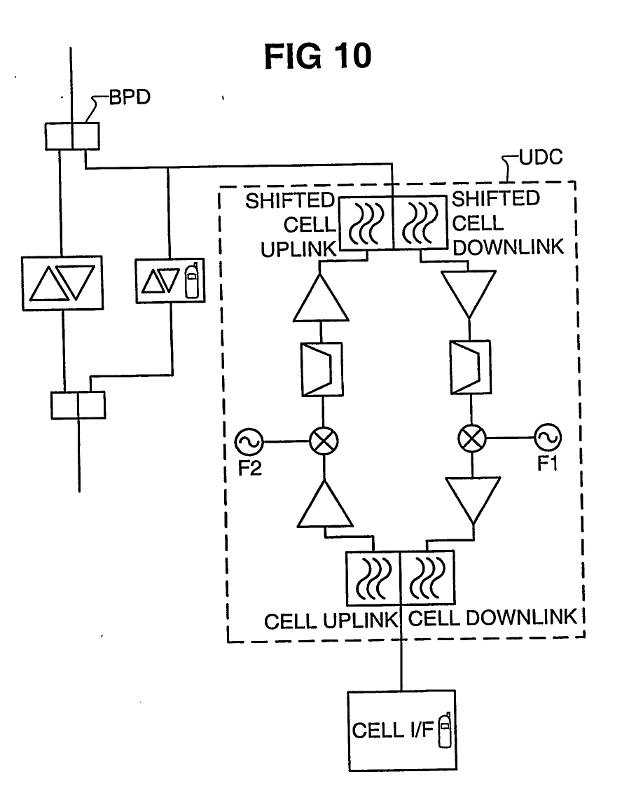

FIG. 10 shows the UDC of the MON. This UDC is the same as that shown in FIG. 6, although any equivalent converter would suffice. It will be appreciated that the input to the UDC is the cellular signals being carried over the cable, in their shifted frequency format. The UDC converts the signals to their normal frequencies, and passes them on to the cellular interface Cell I/F.

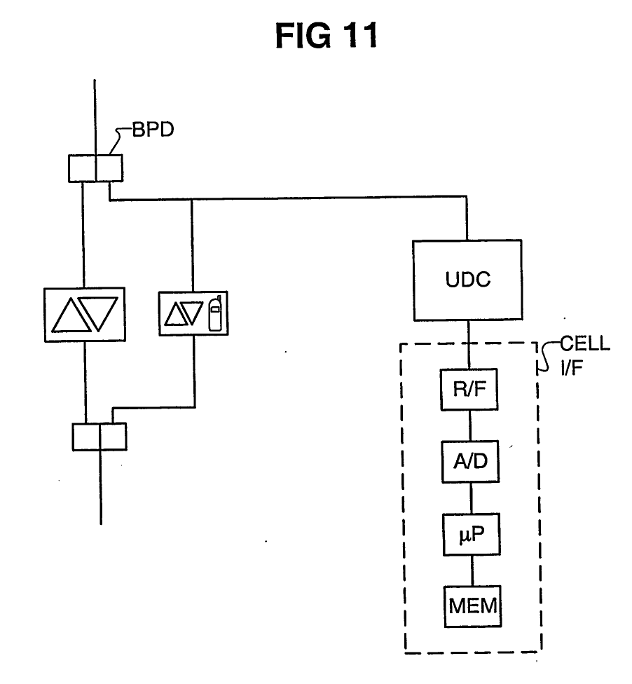

FIG. 11 shows the cell I/F of the monitor MON of the monitor enabled amplifier MEA. In particular, the cell I/F is like a normal cellular phone, and includes a radio frequency unit R/F, an analog to digital converter A/D, a microprocessor, a memory MEM, and other associated components not shown. It will be understood that this is a highly simplified, schematic view of a cellular phone, with details omitted for the sake of clarity. For linguistic convenience, the cell I/F may be thought of as including a microprocessor and a receiver/transmitter unit (RT unit—which itself includes the R/F, A/D, modem, and the like).

The cell I/F is, substantially, a fully functional cellular telephone except that it does not need an antenna (because it transmits and receives signals over the cable of the CATV system) and also does not need a user interface (because it is used as an embedded system and not by a user).

In one embodiment, the cell I/F includes a computer chip that is a standard wireless phone chip. Here, “standard wireless phone chip” means the same kind of chip used in mobile terminals such as telephones or the like. Such chips are extremely economical, costing on the order of below $10. While a custom chip could certainly be used to great advantage, using a standard wireless phone chip makes the implementation of a MEA very inexpensive.

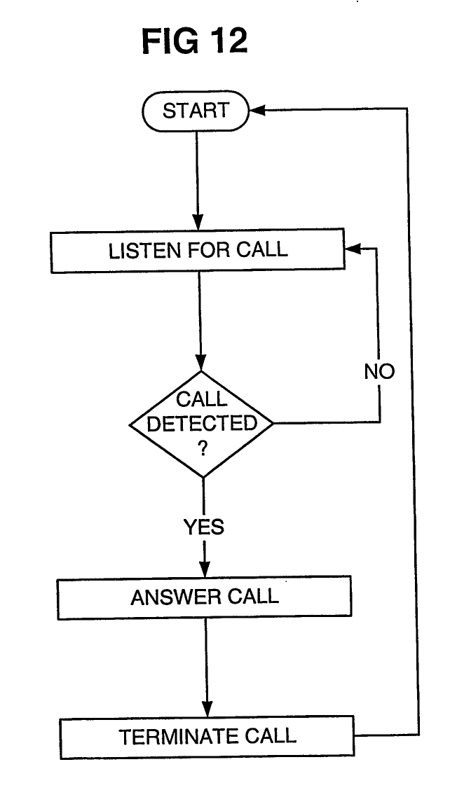

One manner of operating the MEA is shown in FIG. 12. The cell I/F listens for a call. Each cell I/F has its own telephone number, just like any other mobile terminal, and it is therefore straightforward for the cell I/F to determine whether it is being called. If no call is detected, then the cell I/F just continues to wait for a call. If a call is detected, then the cell I/F answers the call and, eventually, the call is terminated either by the network or the cell I/F.

By operating in the manner shown in FIG. 12, the wireless provider can monitor the proper operation of the CATV segment up to at least the MEA to which the cell I/F belongs. That is to say, if it is possible to call the cell I/F through the CATV segment, then the proper operation of the CATV segment up to at least that point is established.

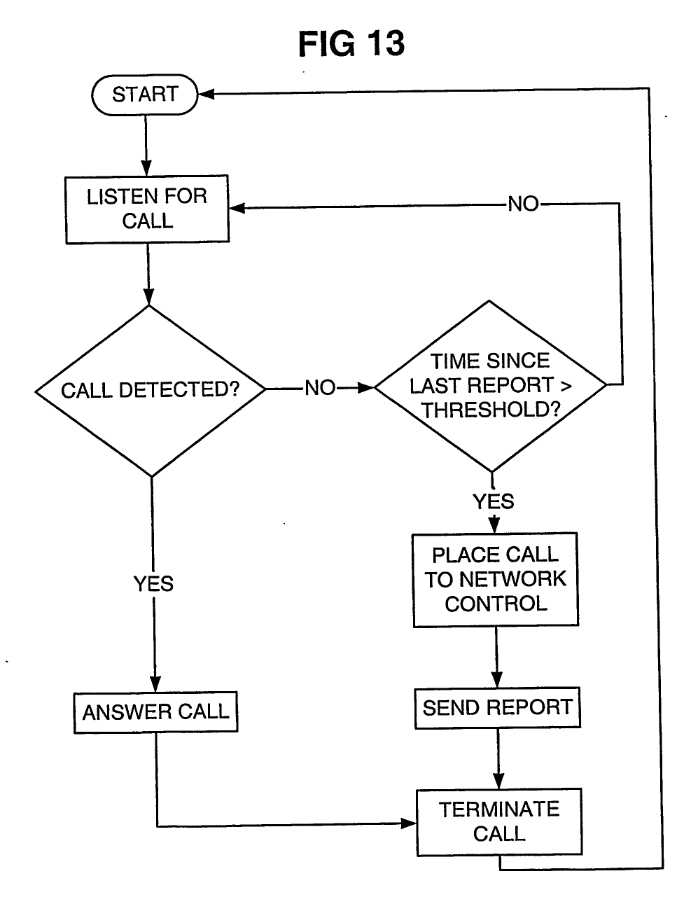

FIG. 13 shows another exemplary manner in which the MEA can be operated. In this embodiment, the cell I/F not only responds to incoming calls (i.e., calls placed as needed for troubleshooting), but also places outgoing calls at predetermined intervals so as to proactively report on its own status.

As shown in FIG. 13, the cell I/F listens for a call to its own telephone number. If a call is detected, the cell I/F answers the call as described already with respect to FIG. 12, and then the call is eventually terminated.

If no call is detected, the cell I/F determines whether the time elapsed since the sending of the last report has exceeded a predetermined threshold. If the threshold has not been exceeded, then the cell I/F simply continues to listen for a call. If the threshold has been exceeded, however, then the cell I/F originates a call to a predetermined telephone number corresponding to a network control center and sends a report. Another, more general way to put this is to say that the cell I/F makes a reporting determination based on the timing of a previous communication. Putting it this way makes clear that any variety of timing approaches could be taken, even including the resetting of time periods upon the occurrence of certain events such as the arrival of an incoming call from the network control center.

It will be appreciated that the sending of the report is optional, and that the simple fact that the call was received at the network control center provides valuable information to the wireless provider as to the proper operation of the CATV segment. Thus, when a call is made, this can be thought of as reporting to the network control center. The optional report could include such information as is available to the cell I/F. For example, software version information could be provided, or date and time information, or signal strength information.

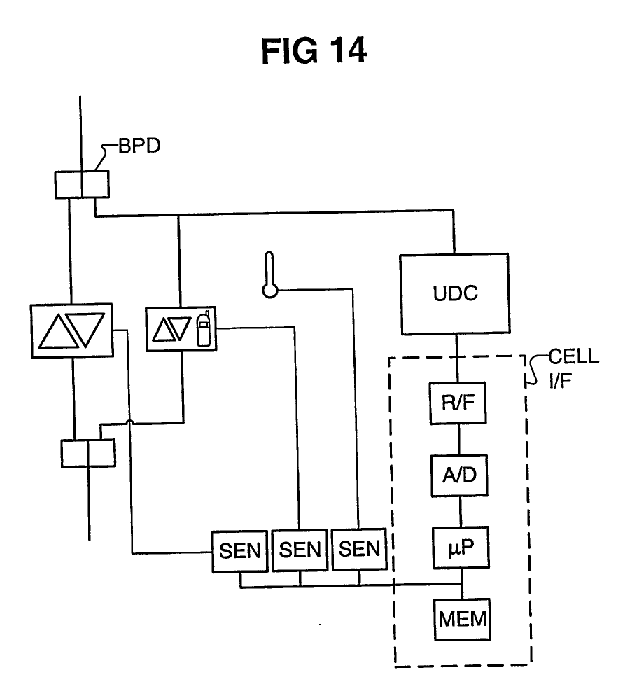

FIG. 14 shows another embodiment of the MON of the MEA. In this exemplary embodiment, the cell I/F is coupled in any well-known manner to one or more sensors. In FIG. 14, the sensors are shown as being connected to the CATV amplifier, the cell amplifier, and a thermometer. This illustrates the fact that the cell I/F could obtain sensor information relating to the operation of the various other components in the MEA.

Moreover, it will be appreciated that, if any of the other devices in the MEA includes a microprocessor or the like, then the cell I/F could obtain status information directly from such a microprocessor without the use of a sensor.

Such information obtained from sensors or other sources could be very helpful in diagnosing problems in the network. For example, if a sensor is able to report on the ambient temperature in the MEA, then the cell I/F could pass this information on to the network control center and values outside of an expected range could be used as a trigger to initiate problem diagnosis activities.

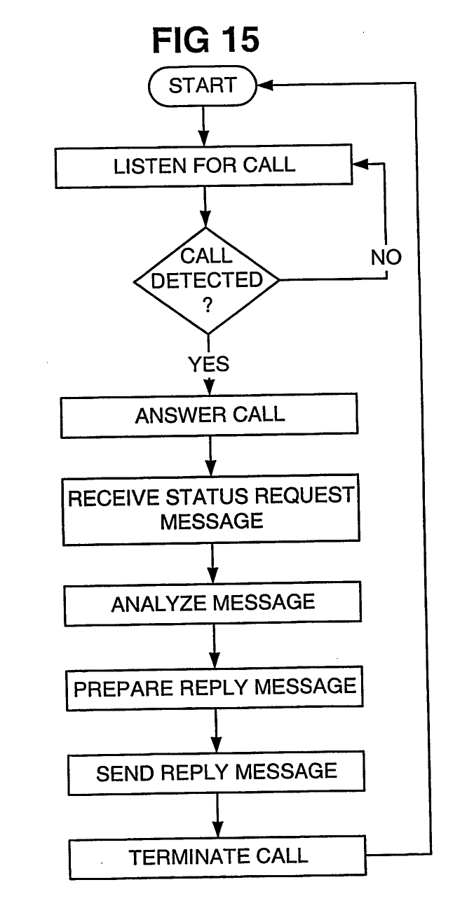

FIG. 15 shows one manner of operating the MEA of FIG. 14. That is to say, the cell I/F listens for a call to its own telephone number. When a call is detected, the cell I/F answers the call and receives a preformatted status request message. After analyzing the message, the cell I/F prepares a reply message which may include sensor information as indicated by the status request message. The reply message is then sent back, and the call is terminated.

It will be appreciated that the use of a preformatted status request message is one option, and that it would equally be possible to simply respond with all available status information to any call.

It will also be appreciated that periodic status reports could be sent in the manner shown in FIG. 13.

It will also be appreciated that the sending of a status reports could be triggered by a sensed value reaching a predetermined threshold or value. For example, if the ambient temperature is detected as being greater than 120 degrees (indicating an unusual condition requiring immediate attention), then the MEA would immediately send a status report including this information.

It will also be appreciated that this embodiment of a cell I/F could still use a standard wireless chip for cellular communications, but include a supplemental microprocessor (not shown) for communicating with the sensors, analyzing status request messages, preparing reply messages, and the like.

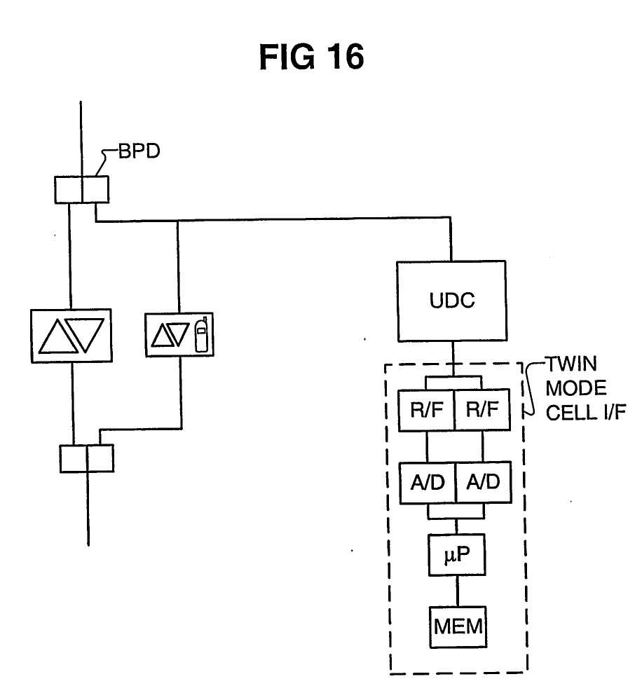

FIG. 16 shows yet another embodiment of the MEA according to an aspect of the invention. In this embodiment, the cell I/F is a twin mode cell I/F. Because it is a twin mode cell I/F, it can provide active monitoring of network cellular activity.

The cell I/F is a twin mode cell I/F because it not only can receive downlink communications and transmit uplink communications on standard cellular frequencies, it can also listen to uplink communications from other cellular terminals. This is a capability that is not normally present in typical cellular terminals, because a given mobile station has no need to listen to the uplink communications of other mobile stations.

The twin mode cell I/F includes extra I/F and A/D equipment so as to enable it to listen to uplink communications from other terminals. In addition, the up and down converter UDC is appropriately modified so as to pass on such uplink communications to the twin mode cell I/F. Such a modification is well within the capability of one familiar with this field. The RF equipment that enables the twin mode cell I/F to receive uplink communications may be thought of as means for receiving uplink communications.

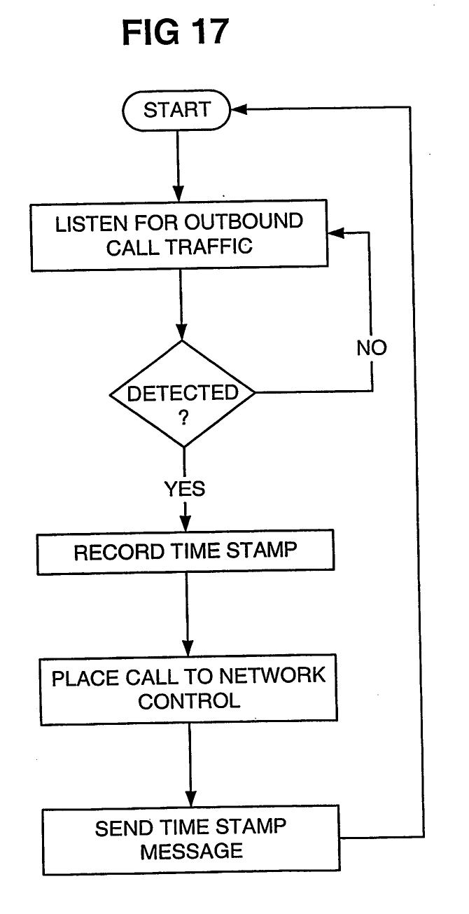

The operation of such a MEA with a twin mode cell I/F is shown in one embodiment in FIG. 17. In FIG. 17, the twin mode cell I/F listens for outbound cellular call traffic. That is to say, it eavesdrops on the line and tries to determine whether any mobile terminals are making outgoing calls from downstream. When such outbound cellular call traffic is detected, cell I/F records a timestamp corresponding to the time of detection, and places a call to the number corresponding to the network control center. When the network control center answers, the cell I/F sends a message that includes the timestamp.

It will be recalled that a record of each telephone call is made at the network control center of the PLMN. By correlating the timestamp of the timestamp message from the cell I/F with the timestamp of a telephone call record pertaining to a particular customer, it is possible for the network control center to make a determination that the call of the particular customer was made along a path that included the MEA.

In other words, the cell I/F can be said to make a detection of cellular call traffic of a mobile terminal that is downstream, and then to report the detection.

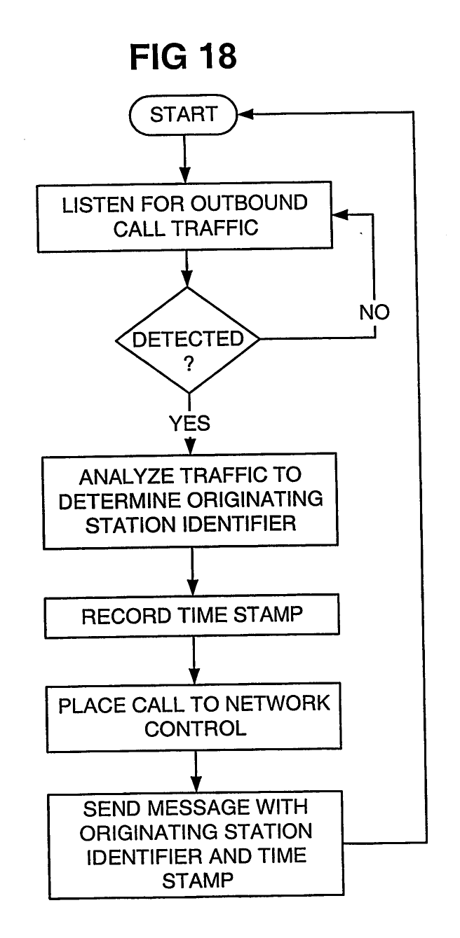

Another mode of operation according to a different exemplary embodiment of the invention as shown in FIG. 18. In FIG. 18, the twin mode cell I/F of the MEA listens for outbound cellular call traffic. When such traffic is detected, the twin mode cell I/F analyzes the traffic to determine an originating station identifier.

The originating station identifier can simply be the ID of the mobile terminal, or the IMSI, or the TMSI, or an IP address or any other identifier depending on the particular cellular system being used. The point about the originating station identifier (OSI) is that it identifies the originating station.

The twin mode cell I/F also records a timestamp. Once this information (i.e., the OSI and the timestamp) is obtained, the MEA makes a cellular call to the network control center and provides a message that includes the OSI and the timestamp.

The network control center can use the timestamp alone, or even the arrival time of a reporting call from the cell I/F without a timestamp, to make a correlation between a given call from a particular user and a call detected by the MEA. This correlation can be made much more accurate by using also the OSI. It will be appreciated that the timestamp is not strictly necessary so long as the correlation is made quickly. This is because the mobile terminal cannot make two calls at the same time, and automated equipment makes it possible to perform this correlation normally prior to the termination of a given call. Nevertheless, the timestamp can be useful to resolve ambiguities.

In the embodiments shown in FIGS. 17 and 18, the timestamp is recorded by the MEA. It is not strictly necessary for the MEA to perform this task. That is to say, the network control center could record its own timestamp at the time the call of the MEA is received.

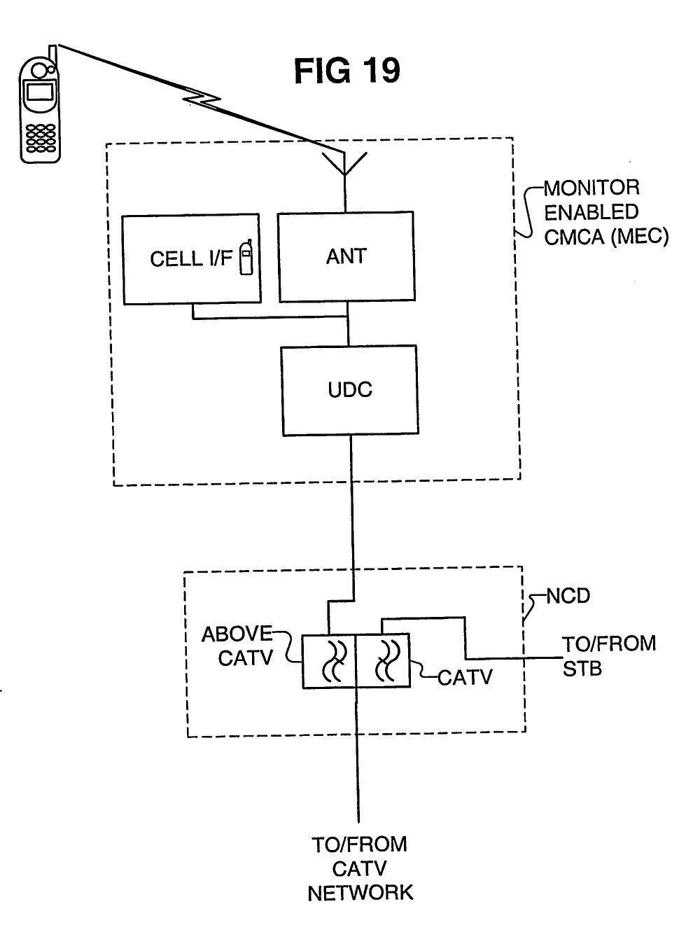

FIG. 19 shows a monitor enabled cable amount cellular antenna (MEC). The MEC is a unit that is to be located at the premises of the user, and includes the components of the CMCA (refer to FIG. 5) as well as a cell I/F. The construction of the cell I/F has already been described with regard to the MEA, and no particular change is necessary for adaptation in an MEC.

As was the case with the MEA, the MEC can operate as shown in FIG. 12, so as to provide troubleshooting and operational information to the wireless provider.

Likewise, the MEC can operate as shown in FIG. 13, so as to place a call to the network control center based on the passage of a predetermined period of time.

Likewise, the MEC can be provided with the ability to monitor sensors (see FIG. 14) and to provide status information in response to a call (as in FIG. 15), or based on the passage of a predetermined period of time, or based on the detection of a sensed value reaching a predetermined threshold or value. Likewise, the MEC can receive inputs from other embedded systems, and therefore need not actually sense every value on which he reports. Thus, another way to put this is to say that the MEC can provide status information based on the detection of a received value reaching the predetermined threshold.

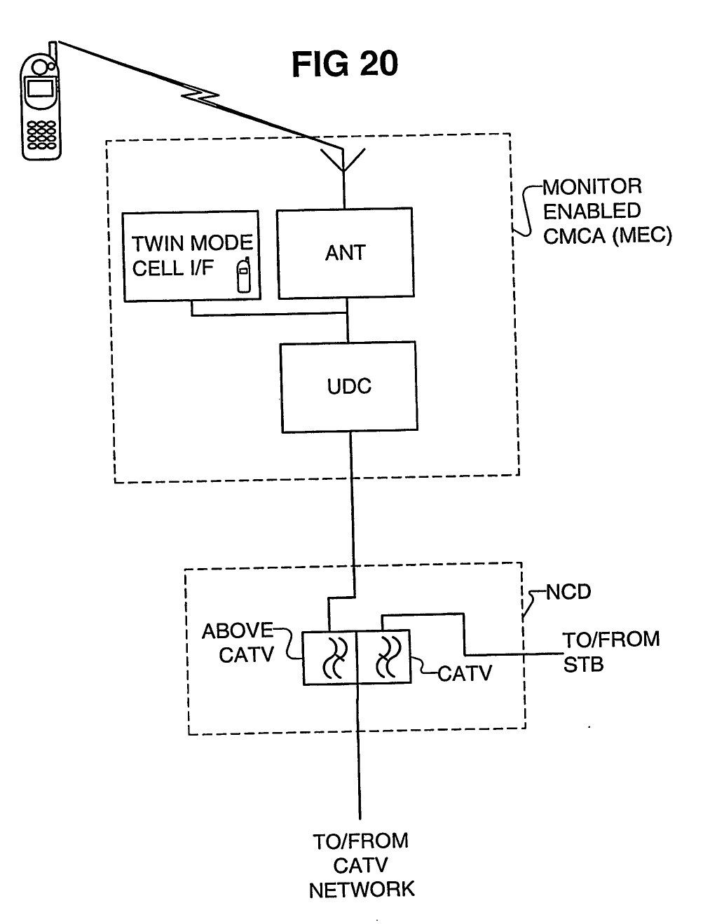

Likewise, the MEC can be provided with a twin mode cell I/F as shown in FIG. 20 (see also the twin mode cell I/F shown in greater detail in the MEA of FIG. 16). When the MEC is provided with a twin mode cell I/F, it can provide, to the network control center, information which can be used for correlation between a call record pertaining to the call of a particular user, at a particular premises and the MEC.

That is to say, the MEC could operate as shown in FIGS. 17 or 18. When a user places an outgoing call via the MEC, a the MEC places its own call to the network control center and provides correlation information such as a timestamp, an originating station identifier OSI, or the like. The network control center can use the correlation information as the basis for a decision that the call of the particular user was originated at the particular MEC.

Because the MEC provides such correlation information, and because the MEC serves only a very small area (i.e., the area near the CATV outlet) it is possible to identify the location of a cellular caller to within a very small geographical area.

The very small area served by the MEC may be thought of as an ultrasmall cell. The cellular system thus can be thought of as including not only cells (corresponding generally to cellular towers, also referred to as macrocells), microcells (corresponding to smaller outdoor areas), and picocells (corresponding to buildings such as auditoriums and malls), but also femtocells (corresponding to the ultrasmall cell of an MEC).

The femtocell is such a small geographical area that it identifies a given apartment within an apartment building, a given office within an office building, and a given house or townhouse.

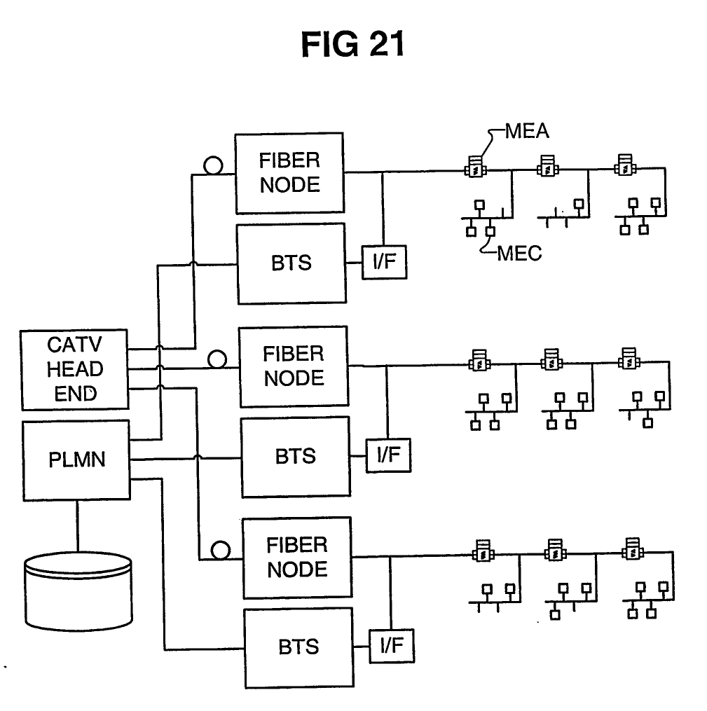

FIGS. 21-23 show one way in which the use of MEAs and MECs can provide an improved caller location system. FIG. 21 shows the CATV head end connected via fiber to fiber nodes. The fiber nodes convert signals from fiber to cable for distribution. The cable includes, as amplifiers, MEAs. Certain subscribers have MECs in their premises.

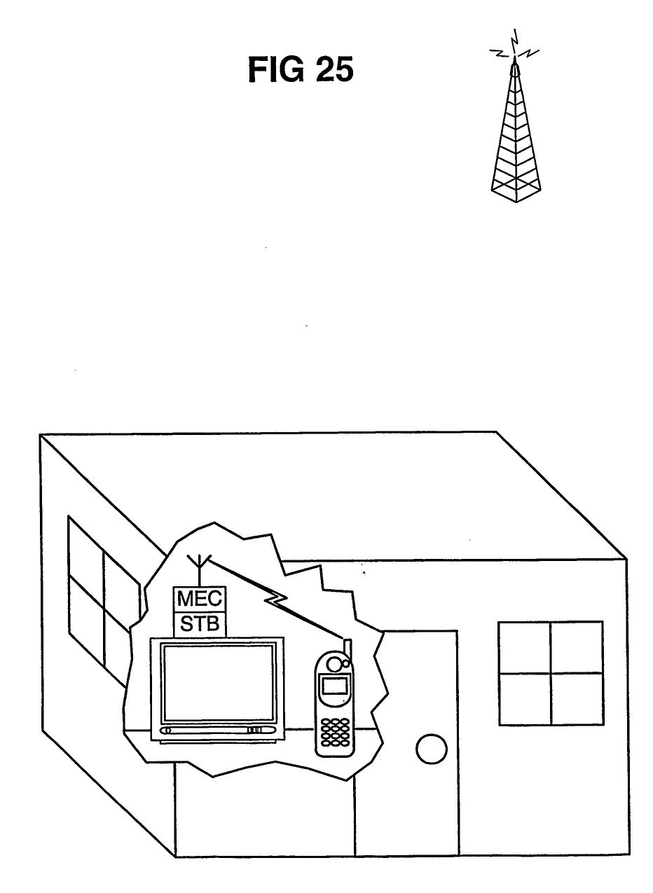

In the implementation shown in FIGS. 21 and 25, there is a base transceiver station BTS or number of BTSs each one corresponding to a different operator or different technology for each fiber node, connected via an interface IF. Such an interface would, of course, include the necessary up and down converter.

Each BTS is connected to the PLMN. A database is depicted as being connected to the PLMN, and this database includes information such as subscriber information and call records.

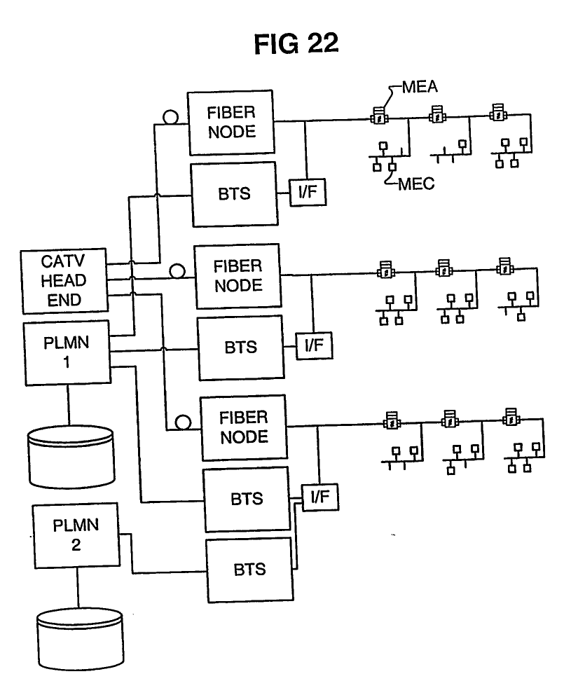

FIG. 22 shows a system similar to that as shown in FIG. 21, but illustrates the fact that more than one wireless provider might provide wireless services over the same or overlapping CATV segment. In FIG. 22, PLMN 1 provides wireless service over all three fiber nodes of the CATV system, and PLMN 2 provides wireless service over only one of the three fiber nodes. Such a system would be thought of as a system in which dual wireless providers provide service over the same CATV system. Of course, any number of subnetworks could be supported and it will be appreciated that the showing of three subnetworks is for the sake of explanation only.

It will be appreciated that such multiple providers could provide wireless service of the same type (e.g., GSM) or could provide wireless service of different cellular types (e.g., GSM and UMTS). Likewise, a given provider could provide itself provide service of different cellular types either alone on one cable system or at the same time as another provider.

In FIG. 22, the BTS of PLMN 1 and the BTS of PLMN 2 both feed into the same interface. The particular manner in which this is performed is not the subject of the present application, but will be readily appreciated by those familiar with this field and can be achieved in a variety of ways.

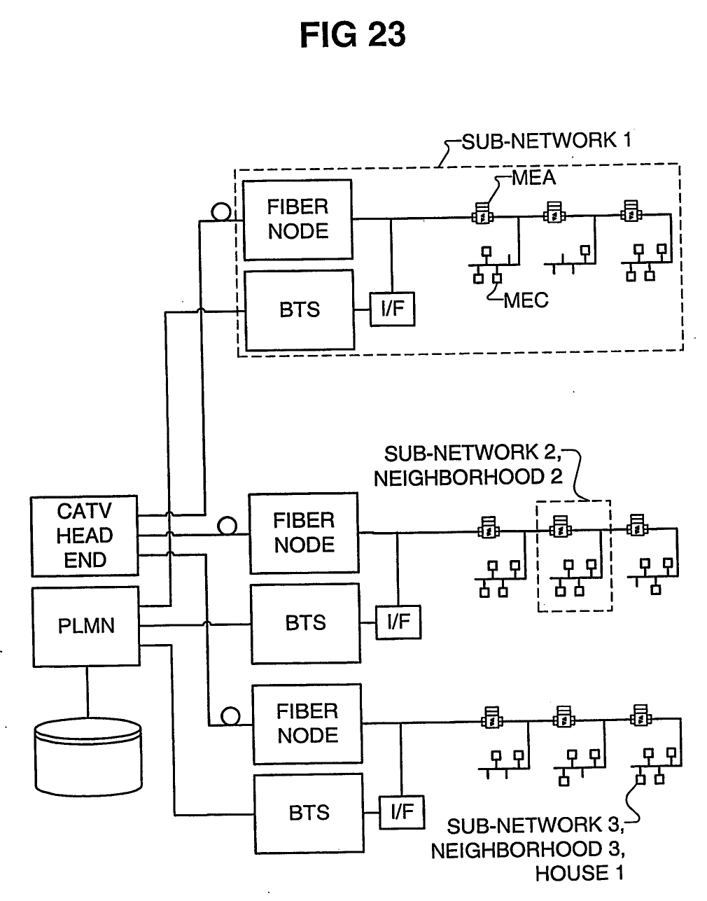

FIG. 23 is similar to FIG. 21 in that it includes only one PLMN, for the sake of simplicity, and includes MEAs of the type having twin mode cell I/F's.

It will be appreciated that each fiber node defines a subnetwork. The three fiber nodes shown in FIG. 23 therefore define three subnetworks. Any call received through a BTS connected to a given fiber node certainly originated in the area of one of the CMCAs connected to that cable.

It will also be appreciated that each MEA defines what may be called a neighborhood. Any call which can be correlated to a given MEA certainly originated in the area provided service by that MEA. It will be appreciated, of course, that each MEA reports each call that it detects. A call from the most furthest downstream neighborhood will thus be reported on each time passes through and MEA. The network control center thus needs to discard redundant reports from MEAs and keep only the report of the furthest downstream MEA as the indicator of the neighborhood from which the call originated.

The identification of a subnetwork and neighborhood of a given caller is thus made possible by the use of MEAs having twin mode cell I/F's. This is the case whether or not the CMCA at the user premises is a regular CMCA, a monitor enabled CMCA (MEC), or a monitor enabled CMCA having a twin mode cell I/F.

If the MEC has a twin mode cell I/F, then it is possible to identify the femtocell from which the call originated, since the cell is ultrasmall. The femto cell could thus indicate even which apartment within a building communicated the call.

In one embodiment, an emergency response system such as 911 is provided with one or more of the subnetwork, neighborhood, and femtocell information, depending on availability, whenever a call to 911 is placed from a mobile terminal through the hybrid CATV/cellular system. This can be accomplished because the location of each MEA and MEC is known, and geographic location information relating to the location of the mobile terminal that has called the emergency response service through the MEA or MEC can therefore be determined based on the location of the monitor sending the detection report.

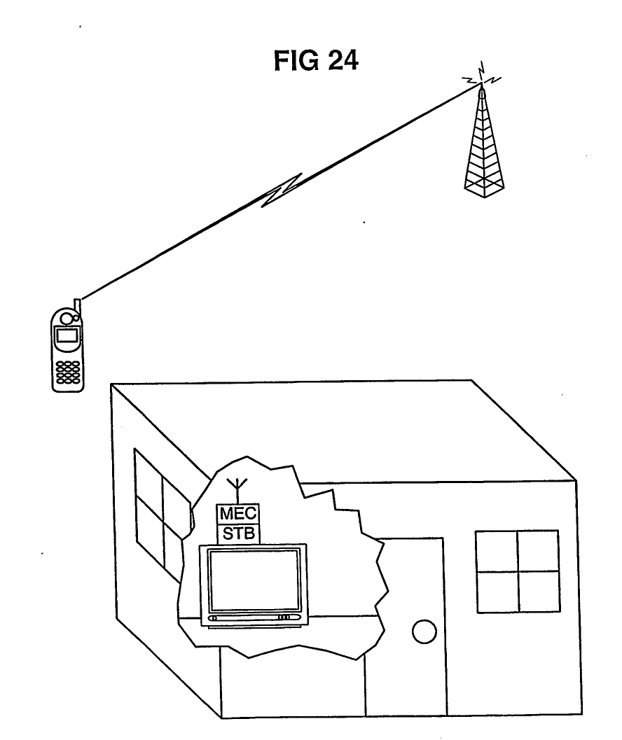

FIGS. 24 and 25 help explain why the area of the femtocell can be so small. FIG. 24 shows a mobile terminal in communication with a first BTS (not shown) via a cellular tower. FIG. 25 shows a mobile terminal in communication with a second BTS (not shown) via the antenna ANT of a CMCA or MEC (MEC hereafter, for the sake of brevity). In this example, “first” and “second” are use for convenience, and not meant to imply order.

In accordance with the well-established standards for cellular communication, when a mobile terminal initializes, it makes a variety of signal strength measurements. The signal strength of the received signals is the normal basis on which the cellular network can assigns the mobile terminal to a cell and its corresponding BTS. The BTS selection is normally made based on the greatest signal strength.

Signal strength measurements also are made from time to time when the mobile terminal is on so that, as the mobile terminal moves from one coverage area to another, a determination can be made as to whether to make another BTS selection and perform a handoff. This BTS selection is also normally made based on the greatest signal strength.

The BTS selection may, of course, be made based on a variety of other criteria as well in addition to the greatest signal strength.

With a system using MECs, however, a different approach is taken.

In particular, the BTS selection is made based not on the greatest signal strength, but, instead, on a minimum threshold criterion. That is to say, the mobile terminal is forced to communicate with the second BTS (i.e., a BTS reached through an MEC) whenever the signal strength at the antenna ANT of the MEC exceeds a minimum threshold.

The transmit power of signals being sent from the MEC antenna ANT is purposefully kept small enough so that, when the mobile terminal is outside of the house as shown in FIG. 24, the received signal strength from the MEC inside the house is not high enough to meet the minimum threshold and so communications is performed through the first BTS. This low transmit power at the MEC, coupled with the setting of the minimum threshold, may be said to be one means for proximity limiting the cell of the MEC to such a small area—a femtocell, interior, about the size of an apartment or a few rooms.

This situation may be described in another way, for linguistic convenience. That is to say, the communication through the MEC is performed with a proximity limiting transmit power at the MEC, and with a minimum receive threshold at the mobile terminal. The proximity limiting transmit power limits the area of communication to the near proximity of the antenna ANT of the MEC, typically to an indoor area of a few rooms.

An example will be given to teach the operational concept The minimum threshold is set to, e.g., −95 Dbm. The user turns on his mobile terminal while inside his house. Various signal strength measurements are made. The signal from the first BTS (through the tower antenna) is received by the mobile terminal at, for example, −55 Dbm, and the signal from the second BTS (through the MEC) is received at −90 Dbm.

Here, even though the stronger signal is received from the first BTS, the cellular network is pre-programmed to force the mobile unit always to lock on to and communicate with the second BTS as long as the minimum threshold is met (i.e., whenever the signal is not at a strength below the minimum threshold).

If the mobile terminal moves from inside the house to outside, the proximity limiting transmit power makes it very unlikely that the second BTS will be received at a level that meets the minimum threshold. Therefore, when the minimum threshold is not met, the BTS selection is based on greatest signal strength, the first BTS is selected, and a handoff is performed.

When the mobile terminal moves from outside to inside, the signal from the second BTS is received at a level that meets the minimum threshold and, even though the power of the signal from the first BTS may be greater, the second BTS is selected.

Communication between the cell phone and the MEC thus can take place at very low power levels, and the mobile terminal in communication with the MEC is necessarily within a very small geographical distance to the MEC.

Since the geographical area served by an MEC is an ultrasmall area, defining a femtocell, is possible not only to provide for improved position location, but also to provide for differential billing that provides a price advantage to the subscriber of a service when using the MEC in his own premises.

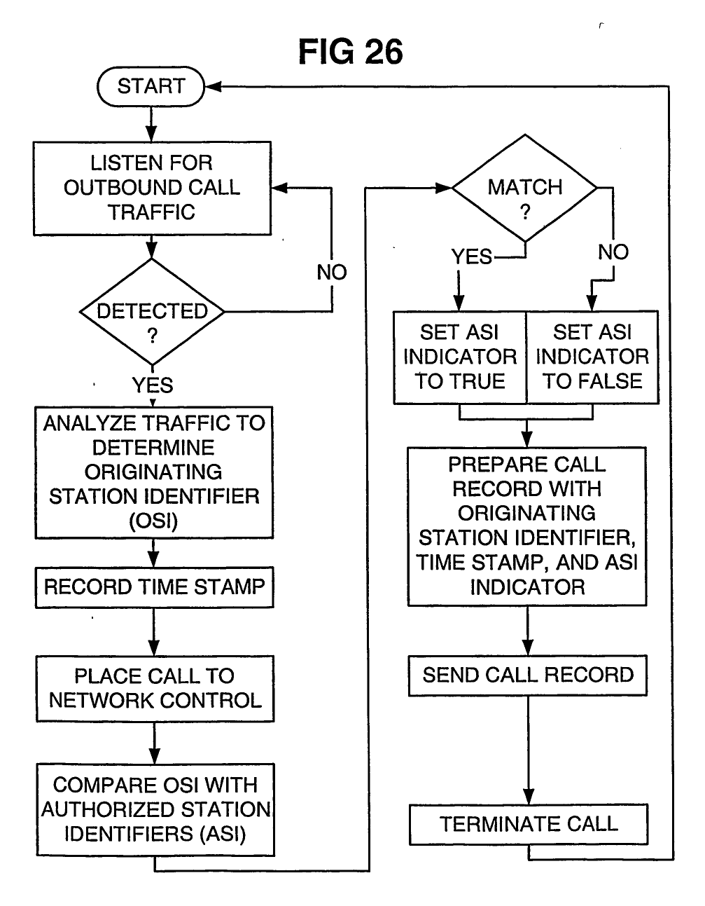

FIG. 26 shows the operation of an MEC, which includes a twin mode cell I/F, according to one embodiment. The MEC listens for outbound call traffic being placed from its area. Once a call is detected, the traffic is analyzed to determine the originating station identifier OSI. A timestamp is optionally recorded, and a call is placed to network control.

The OSI is compared with one or more authorized station identifiers (ASI) that correspond to the particular MEC. That is to say, a wireless provider knows the OSI for each of the registered terminals of a particular user, and also knows the identifier for a given MEC. A correspondence is made in the records of the wireless providers between the identifier of the MEC and the OSI for each of the registered terminals of the user. These registered terminals are said to be the authorized terminals for the purposes of differential billing. Thus, whenever the user uses one of his own terminals to place a cellular call through the MEC in his premises, it can be said that there is a match between the OSI of the user and the list of authorized station identifiers ASI.

When there is a match between the OSI and one of the ASI, and ASI indicator is set to true. Otherwise, the ASI indicator is set to false. For example, when a guest comes to visit the subscriber at his premises, and places an outgoing call using the guest's own equipment, the call is carried by the MEC, but the OSI of the guest does not match any of the identifiers in the ASI list. In such a situation, the ASI indicator would be set to false.

The call record would thus be prepared with the OSI, the timestamp, and the ASI indicator. Thus, the amount to charge for the call could be determined based at least in part on the ASI indicator. That is to say, an especially beneficial rate could be given in a situation in which a subscriber to the cellular over CATV service places a call from his own premises. Likewise, a beneficial rate could be given in a situation in which a subscriber to the cellular over CATV service places a call from the premises of another subscriber, although the premises is not the home of the caller. In such a situation, it could be said that the OSI of the calling party is used to determine whether to charge the call at the rate for a cellular network subscriber, or at the rate for a cellular user who is not a subscriber

The flowchart in FIG. 26 does not necessarily state whether the comparison of the OSI with the ASI is performed by the MEC or the network control center. Either option is possible.

Performing the comparison at the network control center has the advantage of centralized control, but it may be desirable to store the ASI list at the MEC for the sake of decentralized processing of such information or other reasons not foreseen at the present. The ASI list could be stored in the MEC either prior to delivery of the MEC to the subscriber, or it could be stored and/or updated by various messages in predetermined formats passed by making calls from the network control center to the twin mode cell I/F of the MEC.

Although the determination of the OSI has been discussed above with respect to outgoing calls only, it will be appreciated that other circumstances (such as incoming calls) could be occasions on which it might be desirable for the cell I/F to make a report to the network control center.

Although the invention has been described above using some concrete examples for the sake of explanation, it will be appreciated that these examples and the enclosed figures are not intended to limit the scope of the invention, which is to be determined based on the appended claims. Many minor modifications and changes will occur to those familiar with this field, and may be made without departing from the scope and spirit of the invention.

1. A monitor enabled amplifier, comprising:
two bypass devices;
a CATV amplifier coupled between the two bypass devices;
a cellular amplifier coupled between the two bypass devices;
each of the bypass devices passing CATV signals to the CATV amplifier and frequency shifted cellular signals to the cellular amplifier, and
a monitor receiving the frequency shifted cellular signals from one of the bypass devices.

2. The monitor enabled amplifier as set forth in claim 1, wherein the monitor includes:
a frequency converter receiving the frequency shifted cellular signals and outputting cellular signals at unshifted frequencies; and
a cellular interface (cell I/F) communicating cellular signals at unshifted frequencies with the frequency converter.

3. The monitor enabled amplifier as set forth in claim 2, wherein the cell I/F includes a standard wireless phone chip.

4. The monitor enabled amplifier as set forth in claim 2, wherein the cell I/F is a twin mode cell I/F.

5. The monitor enabled amplifier as set forth in claim 4, wherein the twin mode cell I/F includes means for receiving uplink communications.

6. The monitor enabled amplifier as set forth in claim 2, further comprising a sensor connected to the cell I/F.

7. A method of operation for a monitor enabled amplifier (MEA) in a CATV network, comprising:
receiving a frequency shifted cellular signal through a CATV network;
converting the frequency shifted cellular signal to a cellular signal at an unshifted frequency;
automatically responding to the cellular signal.

8. The method of operation for an MEA as set forth in claim 7, further comprising:
making a reporting determination based on the timing of a previous communication; and
when the reporting determination is in the affirmative, reporting by originating a cellular call signal.

9. The method of operation for an MEA as set forth in claim 8, wherein the reporting includes sending a report having one or more of:
timestamp information;
signal strength information; and
status information based on the detection of a received value reaching a predetermined threshold.

10. The method of operation for an MEA as set forth in claim 8, further comprising receiving the received value from a sensor.

11. The method of operation for an MEA as set forth in claim 8, further comprising receiving the received value from another processor.

12. The method of operation for an MEA as set forth in claim 7, wherein the converting of the frequency shifted cellular signal to a cellular signal at an unshifted frequency is performed for only downlink communications.

13. The method of operation for an MEA as set forth in claim 7, wherein the converting of the frequency shifted cellular signal to a cellular signal at an unshifted frequency is performed for downlink communications and also for uplink communications from mobile terminals.

14. The method of operation for an MEA as set forth in claim 13, wherein automatically responding to the cellular call signal comprises:
making a detection of cellular call traffic of a mobile terminal; and
reporting the detection.

15. The method of operation for an MEA as set forth in claim 14, wherein the reporting includes providing a timestamp.

16. The method of operation for an MEA as set forth in claim 14, wherein the reporting includes providing an originating station indicator (OSI) pertaining to the mobile terminal.

17. A monitor enabled cable mount cellular antenna (MEC), comprising:
an antenna unit,
a frequency converter, and
a cellular interface (cell I/F);
wherein the frequency converter communicates unshifted cellular signals with the antenna unit and the cell I/F.

18. The MEC as set forth in claim 17, wherein the cell I/F includes:
a processor, and
a receiver/transmitter (RT) unit under control of the processor.

19. The MEC as set forth in claim 17, wherein the frequency converter is adapted to convert cellular signals between an unshifted format and a frequency shifted format.

20. The MEC as set forth in claim 17, wherein the processor and RT unit are part of a standard wireless phone chip.

21. The MEC as set forth in claim 17, wherein the cell I/F is a twin mode cell I/F.

22. The MEC as set forth in claim 19, wherein the twin mode cell I/F includes means for receiving uplink communications.

23. The MEC as set forth in claim 17, further comprising a sensor connected to the cell I/F.

24. A method of operation for a monitor enabled cable mount cellular antenna (MEC) in a CATV network, comprising:
receiving a frequency shifted cellular signal through a CATV network;
converting the frequency shifted cellular signal to a cellular signal at an unshifted frequency;
automatically responding to the cellular signal.

25. The method of operation for an MEC as set forth in claim 24, further comprising:
making a reporting determination based on the tiring of a previous communication; and
when the reporting determination is in the affirmative, reporting by originating a cellular call signal.

26. The method of operation for an MEC as set forth in claim 25, wherein the reporting includes sending a report having one or more of:
timestamp information;
signal strength information; and
status information based on the detection of a received value reaching a predetermined threshold.

27. The method of operation for an MEC as set forth in claim 25, further comprising receiving the received value from a sensor.

28. The method of operation for an MEC as set forth in claim 25, further comprising receiving the received value from another processor.

29. The method of operation for an MEC as set forth in claim 24, wherein the converting of the frequency shifted cellular signal to a cellular signal at an unshifted frequency is performed for only downlink communications.

30. The method of operation for an MEC as set forth in claim 24, further comprising:
receiving, from an antenna unit, an uplink cellular signal at an unshifted frequency;
automatically responding to the uplink cellular signal.

31. The method of operation for an MEC as set forth in claim 30, wherein the automatically responding to the uplink cellular signal comprises:
making a detection of cellular call traffic of a mobile terminal; and
reporting the detection by placing a cellular call.

32. The method of operation for an MEC as set forth in claim 31, wherein the reporting includes providing a timestamp.

33. The method of operation for an MEC as set forth in claim 31, wherein the reporting includes providing an originating station indicator (OSI) pertaining to the mobile terminal.

34. The method of operation for an MEC as set forth in claim 31, wherein the reporting includes:
determining an originating station indicator (OSI) pertaining to the mobile terminal;
making a comparison between the OSI and one or more authorized station identifiers (ASI);
determining the value of an ASI indicator based on the comparison.

35. A method of cellular communications, comprising:
communicating a cellular signal between a mobile terminal and a base transceiver station via an indoor antenna and a CATV network;
converting the frequency of the cellular signal to a shifted frequency when the cellular signal is in the CATV network;
bypassing the frequency shifted cellular signal around active components of the CATV network;
amplifying the frequency shifted cellular signal using cellular amplifiers; and
converting the frequency shifted cellular signal back to an unshifted frequency when the cellular signal leaves the CATV network for the base transceiver station or the mobile terminal; and
providing a monitor, comprising a frequency converter and a cellular interface (cell I/F) capable of placing a cellular call, at one or more of:
one of the amplifiers, and
the indoor antenna.

36. The method of cellular communications as set forth in claim 35, wherein the monitor performs the operations of:
receiving a frequency shifted cellular downlink signal through the CATV network;
converting the frequency shifted cellular signal to a cellular signal at an unshifted frequency;
automatically responding to the cellular signal.

37. The method of cellular communications as set forth in claim 36, further comprising:
making a reporting determination, at the monitor, based on the timing of a previous communication; and
when the reporting determination is in the affirmative, reporting by originating a cellular call signal from the monitor.

38. The method of cellular communications as set forth in claim 37, wherein the reporting includes sending a report having one or more of:
timestamp information;
signal strength information; and
status information based on the detection of a received value reaching a predetermined threshold.

39. The method of cellular communications as set forth in claim 37, further comprising receiving the received value from a sensor.

40. The method of cellular mutations as set forth in claim 37, further comprising receiving the received value from another processor.

41. The method of cellular communications as set forth in claim 37, further comprising:
receiving, at the monitor, an uplink cellular signal; and
automatically responding to the uplink cellular signal.

42. The method of cellular communications as set forth in claim 41, wherein the automatically responding to the uplink cellular signal comprises:
making a detection of cellular call traffic of a mobile terminal; and
reporting the detection by placing a cellular call.

43. The method of cellular communications as set forth in claim 42, wherein the reporting includes providing correlation information.

44. The method of cellular communications as set forth in claim 42, wherein the reporting includes providing an originating station indicator (OSI) pertaining to the mobile terminal.

45. The method of cellular communications as set forth in claim 42, further comprising:
determining an originating station indicator (OSI) pertaining to the mobile terminal;
making a comparison between the OSI and one or more authorized station identifiers (ASI) corresponding to the monitor;
determining the value of an ASI indicator based on the comparison.

46. The method of cellular communications as set forth in claim 45, further comprising storing the value of the ASI indicator in a call record.

47. The method of cellular communications as set forth in claim 46, further comprising determining a charge for a call to which the call record pertains based on the value of the ASI indicator.

48. The method of cellular communications as set forth in claim 47, wherein the charge, when the value of the ASI indicator indicates a match between the OSI and ASI, is less than the charge when the value of the ASI indicator indicates no match.

49. The method of cellular communications as set forth in claim 47, wherein the charge, when the value of the OSI indicates a cellular network subscriber is less than the charge when the value of the OSI indicates a non-subscriber cellular user.

50. The method of cellular communications as set forth in claim 42, wherein, when the cellular call traffic of the mobile terminal is a call to an emergency response service, geographic location information relating to the location of the mobile terminal is determined based on the location of the monitor sending the detection report.

51. A cellular communications system with a hierarchical cell structure comprising:
macrocells corresponding to cellular towers and having corresponding outdoor service areas;
microcells corresponding to outdoor areas smaller than the outdoor service areas of the macrocells;
picocells corresponding having indoor service areas corresponding to buildings; and
femtocells corresponding to monitor enabled cable mount cellular antennas (MECs) and having corresponding indoor service areas smaller than the indoor service areas of the picocells.

52. The cellular communications system as set forth in claim 51, further comprising a CATV network communicating a cellular signal between a mobile terminal and a base transceiver station via one of the MECs.

53. The cellular communications system as set forth in claim 52, wherein the frequency of the cellular signal is converted to a frequency shifted cellular signal when the cellular signal is in the CATV network.

54. The cellular communications system as set forth in claim 53, further comprising, at active components of the CATV network, a respective cellular bypass, wherein the cellular bypass bypasses the frequency shifted cellular signal around the active component.

55. The cellular communications system as set forth in claim 54, wherein the cellular bypass includes and amplifier amplifying the frequency shifted cellular signal.

56. The cellular communications system as set forth in claim 55, wherein the MEC further comprises:
a frequency converter converting between the cellular signals and the frequency shifted cellular signals, and
a cellular interface (cell I/F) capable of placing a cellular call by communicating cellular signals, connected to the frequency converter.

57. The cellular communications system as set forth in claim 55, further comprising a monitor having a frequency converter and a cellular interface (cell I/F) capable of placing a cellular call, at the cellular bypass, the frequency converter communicating cellular signals at unshifted frequencies with the cell I/F, and communicating frequency shifted cellular signals with the CATV network.

58. The cellular communications system as set forth in claim 51, further comprising:
a first base transceiver system (BTS) supporting communications for one of said macrocells; and
a second BTS, supporting communications for one of said femtocells located geographically in said one of said macrocells;
wherein, when a mobile terminal receives a signal from the first BTS at a first signal strength, and receives a second signal from the second BTS at a second signal strength, the cellular communications system forces the mobile terminal to communicate via the second BTS when the second signal strength exceeds a predetermined threshold, even when the first signal strength exceeds the second signal strength.

59. A computer supported method for determining a charge for a cellular call, comprising:
making a correspondence determination as to whether an originating station identifier (OSI) of a mobile terminal originating the cellular call corresponds to any of a set of one or more authorized station identifiers (ASI) associated with a particular cellular antenna through which the cellular call was communicated;
when the correspondence determination indicates a match, calculating the charge at a first charge rate; and
when the correspondence determination indicates no match, calculating the charge at a charge rate higher than the first charge rate.

60. The computer supported method for determining a charge for a cellular call as set forth in claim 59, wherein the correspondence determination is based on an ASI indicator included in a call record relating to the cellular call.

61. The computer supported method for determining a charge for a cellular call as set forth in claim 59, further comprising:
when the correspondence determination indicates no match, whether the OSI indicates a cellular network subscriber or a non-subscriber cellular user;
when the OSI indicates a cellular network subscriber, calculating the charge at a second charge rate higher than the first charge rate; and
when the OSI indicates a non-subscriber cellular user, calculating the charge at a third charge rate higher than the second charge rate.

62. A method for identifying the location of a cellular caller, comprising:
detecting the origination of a call, by the cellular caller, at a monitor enabled cable mount cellular antenna (MEC);
automatically placing a call from a monitor of the MEC in response to the detecting of the call;
making a correlation between the call of the cellular caller and the call from the monitor; and
identifying the location of the cellular caller as the location of the MEC.

63. The method for identifying the location of a cellular caller as set forth in claim 62, further comprising:
sending, from the monitor to a network control center, correlation information; and
at the network control center, using the correlation information to make the correlation.

64. The method for identifying the location of a cellular caller as set forth in claim 63, wherein the correlation information comprises a timestamp relating to the time the call from the cellular caller was detected at the monitor.

65. The method for identifying the location of a cellular caller as set forth in claim 63, wherein the correlation information comprises an originating station identifier (OSI) corresponding to the cellular caller.
